(19) United States
(12) Patent Application Publication
(10) Pub. No.: US 2018/0124909 A1
(43) Pub. Date: May 3, 2018

(54) THREE PHASE ALTERNATING CURRENT TO THREE PHASE ALTERNATING CURRENT ELECTRICAL TRANSFORMER

(71) Applicant: Tibbar Plasma Technologies, Inc., Los Alamos, NM (US)

(72) Inventors: Keith Moser, Libertyville, IL (US); Richard Nebel, Los Alamos, NM (US); Liviu Popa-Simil, Los Alamos, NM (US); Cihan Ackay, Los Alamos, NM (US); Daniel Barnes, Lamy, NM (US); Juan Fernandez, Los Alamos, NM (US); John Finn, Los Alamos, NM (US); William Gibson, Los Alamos, NM (US); Aaron McEvoy, Los Alamos, NM (US)

(21) Appl. No.: 15/339,774

(22) Filed: Oct. 31, 2016

(51) Int. Cl. H05H 1/16; H01F 38/14

(52) U.S. Cl. CPC H05H 1/16; H01F 38/14

(57) ABSTRACT

An apparatus and corresponding systems and methods for managing electric power, particularly a transformer system and method, and more specifically a transformer for transforming three-phase alternating current. An example apparatus includes a chamber configured to contain plasma. The apparatus includes input electrodes disposed at least partially within the chamber, and configured to receive a first three-phase AC current input into the chamber. The input electrodes are configured to cause the input AC current to induce motion in the plasma. Motion induced in the plasma transforms current flowing there-through. Output electrodes extend from the chamber, which output electrodes may be rotated in a controlled manner. The output electrodes conduct a second three-phase alternating current, from the induced motion in the plasma, for delivery from the chamber.

### CROSS-REFERENCE TO RELATED APPLICATIONS

This application is related to U.S. patent application Ser. No. 15/209,907, filed Jul. 14, 2016, the entire disclosure of which is hereby incorporated by reference.

### STATEMENT REGARDING FEDERALLY SPONSORED RESEARCH OR DEVELOPMENT

This invention was made with Government support under Award No. DE-AR0000677, awarded by the Advanced Research Projects Agency—Energy (ARPA-E), U.S. Department of Energy. The Government has certain rights in this invention.

### BACKGROUND OF THE INVENTION

Three Phase AC Transformers use iron cores and windings to transform voltages and currents. These transformers are large, bulky and expensive. This disclosure describes a new type of three phase transformer that utilizes plasmas to transform voltages and currents. It can also transform phases and frequencies for three phase power.

### SUMMARY OF THE INVENTIVE DISCLOSURE

It is to be understood that both the following summary and the following detailed description are exemplary and explanatory only and are not restrictive. Provided are methods and systems for, in one aspect, managing three phase alternating current (AC) power. Provided are methods and systems for, in another aspect, transforming three phase AC power.

In an aspect, systems and methods of the present disclosure transform three phase AC voltages and currents, while minimizing cost and complexity. In another aspect, instead of using wires and iron cores similar to known three phase AC transformers, the plasma-based three phase AC transformer systems of the present disclosure can comprise plasma, helical electrodes, and an axial magnetic field. As an example, the transformation of the three phase AC voltages and currents can be based on known principles of magnetohydrodynamics (MHD) dynamo behavior.

In another aspect, an example system can comprise plasma disposed in a housing and three or more helical electrodes disposed in the housing, wherein an electric current passing through the three or more helical electrodes (as input electrodes) induces a rotation in the plasma. Conductive end caps can be coupled to the housing and the helical electrodes.

In yet another aspect, a method can comprise generating a magnetic field through plasma and generating a rotation in the plasma, thereby generating a second electric current.

In another aspect, an example apparatus can comprise a chamber configured to contain plasma. The apparatus can comprise at least three input electrodes disposed at least partially within the chamber and configured to receive a three phase alternating current into the chamber. The at least three input electrodes can be configured to direct the three phase alternating current to induce motion in the plasma. The apparatus can comprise at least three output electrodes extending from the chamber. The at least three output electrodes can be configured to conduct a three phase alternating current from the chamber based on the induced motion in the plasma. This three phase power from the secondary can be either higher voltage (step up) or lower voltage (step down) than the primary voltage.

In another aspect, an example method can comprise conveying a three phase alternating current into a chamber, inducing motion in a plasma contained in the chamber based on the three phase alternating current, and receiving a second three phase alternating current from the chamber based on the motion of the plasma induced by the first three phase alternating current.

In another aspect, an example system can comprise a transformer configured to transform a first three phase alternating current to a converted or changed three phase alternating current. The transformer can comprise a chamber configured to contain plasma and at least three (e.g., three or more) input electrodes disposed at least partially within the chamber and configured to direct the first three phase alternating current to induce motion in the plasma thereby generating a second three phase alternating current with transformed voltages and currents. The transformer can comprise at least three output electrodes to conduct or convey three phase alternating current from the transformer. The system can comprise an electrical delivery network electrically coupled to the at least three output electrodes and configured to conduct the three phase alternating current to at least one remote location.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a diagrammatic sectional view of axial current density superposed on a split electrode configured to produce three phase AC power in a system according to the present invention;

FIG. 1B is a block diagram of an exemplary computing device in accordance with the present invention;

FIG. 2 is a perspective view of an exemplary transformer system according to the present invention;

FIG. 3A is a perspective view of an exemplary transformer assembly;

FIG. 3B is an exploded perspective view of an exemplary transformer assembly;

FIG. 4 is an axial view of a split electrode configured to produce three phase AC power according to the present invention;

FIG. 5 is a cross-section view of an exemplary transformer system;

FIG. 6 is a flow diagram of an exemplary method;

FIG. 7 is a conceptual diagram of an exemplary possibly rotating split electrode system to produce three phase alternating current power at an arbitrary, but specified, phase and frequency;

FIG. 8 is a circuit diagram illustrating an exemplary system for transforming electrical current according to the present invention; and

FIG. 9 is a flow chart illustrating an exemplary method for transforming an electrical current.

The various views are not necessarily to scale, either within a particular view or between views.

### DETAILED DESCRIPTION OF EMBODIMENTS

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Herein disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this disclosure including, but not limited to, steps in disclosed methods. Thus, if there are a variety of additional steps that can be performed, it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following descriptions.

As will be appreciated by one skilled in the art, the methods and systems disclosed herein, and sub-methods and subsystems, may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software routines and algorithms. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It is understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

The computer program instructions according to this disclosure may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus, to produce a computer-implemented process such that the instructions that are executed on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and methods, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The systems and methods of the present disclosure generally involve inducing a flow in plasma, and exploiting the plasma flow to realize a current transformation. Flows can be induced in plasmas by applying an electric field perpendicular to the magnetic field. The ideal MHD Ohm's law can be written as:

E+VxB=0, (1)

where E is the local electric field, V is the local plasma velocity, and B is the local magnetic field, and x signifies the vector cross product. Bold face indicates quantities which are vectors.

If equation (1) is crossed with the magnetic field B, it can be determined that the plasma flow perpendicular to the magnetic field (denoted as V_{ExB} and commonly referred to as the ExB drift velocity) becomes:

V_{ExB}=(ExB)/B², (2)

where x signifies vector cross product, and B² is the vector dot product of B with itself.

In order for the ExB drift velocity to change the magnetic field significantly, it must be comparable to the Alfven speed (V_{A}) which can be expressed as:

V_{A}≡B/(μ₀ρ)^{1/2}, (3)

where B is the magnitude of the magnetic field, ρ is the mass per unit volume, and μ₀ is the permittivity of free space. Equation (1) can be combined with Faraday's law:

∂B/∂t=−curl(E) (4)

and integrated over a surface. As such, the result calculation provides that the magnetic field lines (or the magnetic flux) are substantially frozen into the plasma. As an example, the magnetic field lines convect with the plasma.

When plasma velocities approach the Alfven speed (V_{A}) the plasma velocities can bend the magnetic field lines. Thus, if a velocity shear is induced in the perpendicular velocity (e.g., the V_{ExB} drift velocity) along a magnetic field line, the magnetic field can be significantly modified (provided that the flow speeds are near the Alfven speed (V_{A}).

Three-dimensional nonlinear plasma simulations (resistive magnetohydrodynamics (MHD)) can be used to confirm aspects of the phenomenon described herein above. As an example, simulation code similar to that implemented in A. Y. Aydemir, D. C. Barnes, E. J. Caramana, A. A. Mirin, R. A. Nebel, D. D. Schnack, A. G. Sgro, Phys Fluids 28, 898 (1985) and D. D. Schnack, D. C. Barnes, Z. Mikic, D. S. Harned, E. J. Caramana, R. A. Nebel, Computer Phys Comm 43, 17 (1986), can be used. As a further example, plasma can be simulated in cylindrical geometry.

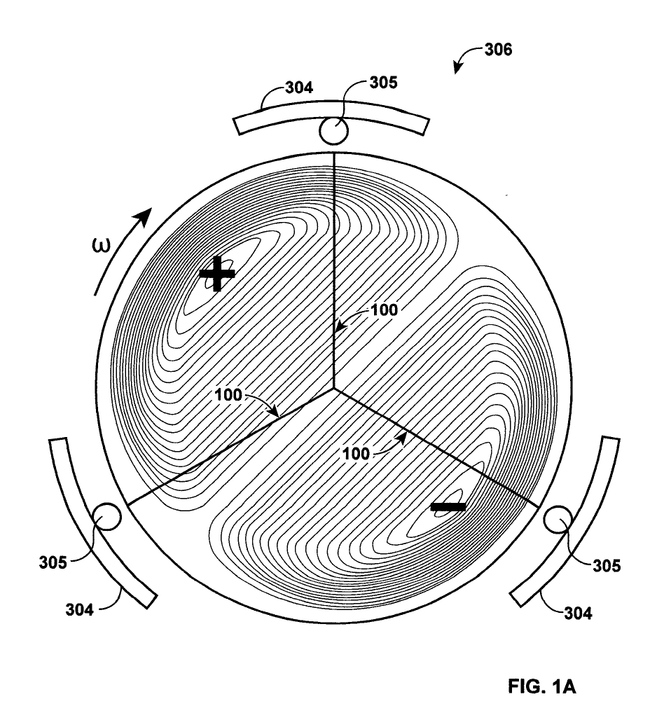

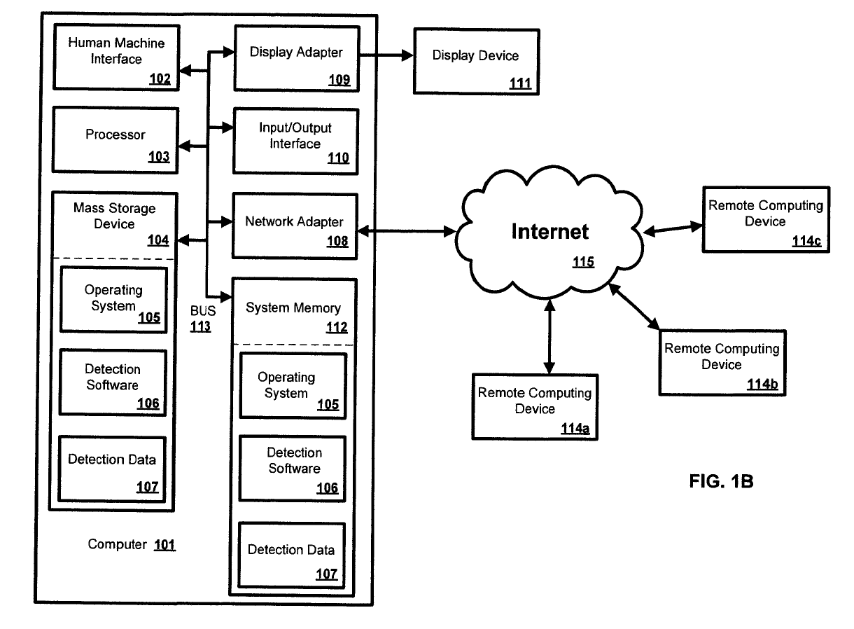

In an aspect, an axial magnetic field can be applied along a helical electric field (e.g., provided via a pair of helical electrodes on the boundary). Such simulation can be plotted as current contours, as shown in FIG. 1A.

The J_{z} value that is plotted is defined as:

μ₀J_{z}=[curl(B)]_{z} , (5)

where J_{z} is the axial current density.

As illustrated in FIG. 1A, the J_{z} contours produced by the MHD simulations can be superposed on a split electrode, labeled as 306. These contours can be symmetric or asymmetric. The electrode according to the present apparatus and system can be split into three pieces, separated by one or more respective insulators labeled as 100. The setup shown in FIG. 1A is used to convert a first three phase AC to a second three phase AC. The helical electrodes, which are disposed within a plasma chamber to be described further, are labeled as 304. The connector leads are labeled as 305. The endcap 306 can be fixed or rotatable. Rotating the split electrode endcap 306 a selected amount changes the phase between the primary and the secondary. This system accordingly can be used to transfer power between grids that have different phases. By rotating the split electrode 306 in one direction at ω=600 Revolutions Per Minute (RPM), the device will convert 60 Hz three phase AC to 50 Hz three phase AC. Similarly, rotating the split electrode 306 at ω=600 RPM in the opposite direction will convert 50 Hz three phase AC power to 60 Hz three phase AC power. The plasma moving in the chamber produces two axial electrical currents that travel in opposite directions, labeled + and − in FIG. 1A.

FIG. 1B is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, dynamos, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

With attention invited to FIG. 1B, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, detection software 106, detection data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as detection data 107 and/or program modules such as operating system 105 and detection software 106 that are immediately accessible to and/or are presently operated on by the processing unit 103.

The computer 101 may also comprise other removable/non-removable, volatile/non-volatile computer storage media. By way of example, FIG. 1B illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and detection software 106. Each of the operating system 105 and detection software 106 (or some combination thereof) can comprise elements of the programming and the detection software 106. Detection data 107 can also be stored on the mass storage device 104. Simulation data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

A user can enter commands and information into the computer 101 via an input device (not shown). Examples of known such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

A display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein, particularly with reference to FIG. 1B, as discrete blocks, although it is recognized that such programs and components reside at various times in different storage components of the computing device 101, and are executed by the data processor(s) of the computer. An implementation of detection software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

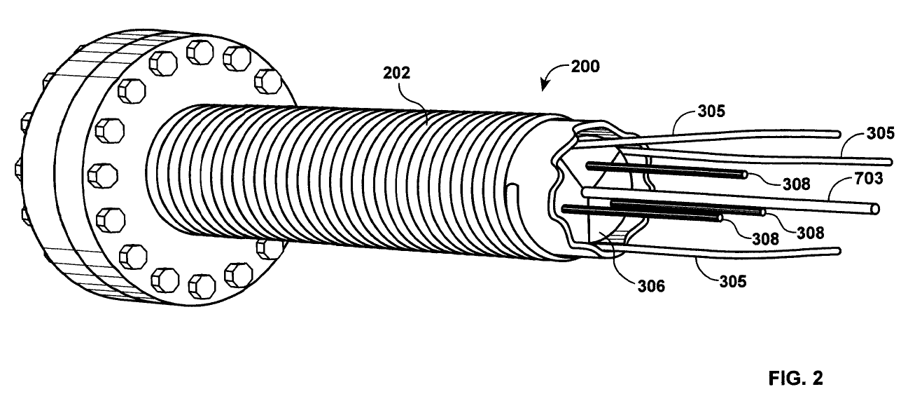

FIG. 2 illustrates a cylindrical vacuum chamber 200 of a transformer system according to the present disclosure. Plasma (not shown) can be disposed in the chamber 200. As an example, a conductor 202 (e.g., wire) can be disposed around a periphery of the housing forming the chamber 200. As a further example, wire conductor 202 can be wound about the chamber 200 to define a solenoid that provides an axial magnetic field when current flows through the conductor. Accordingly, the solenoid disposed around at least a portion of an external wall of the chamber 200; electric current passing through the solenoid induces a magnetic field within the chamber in an axial direction of the solenoid. Input leads 305 are in communication with input electrodes not seen in FIG. 2; output leads 308 are in conductive communication with respective segments of the split electrode 306. The stalk or shaft 703 optionally is used to rotate the split electrode 306 at selectively variable speed.

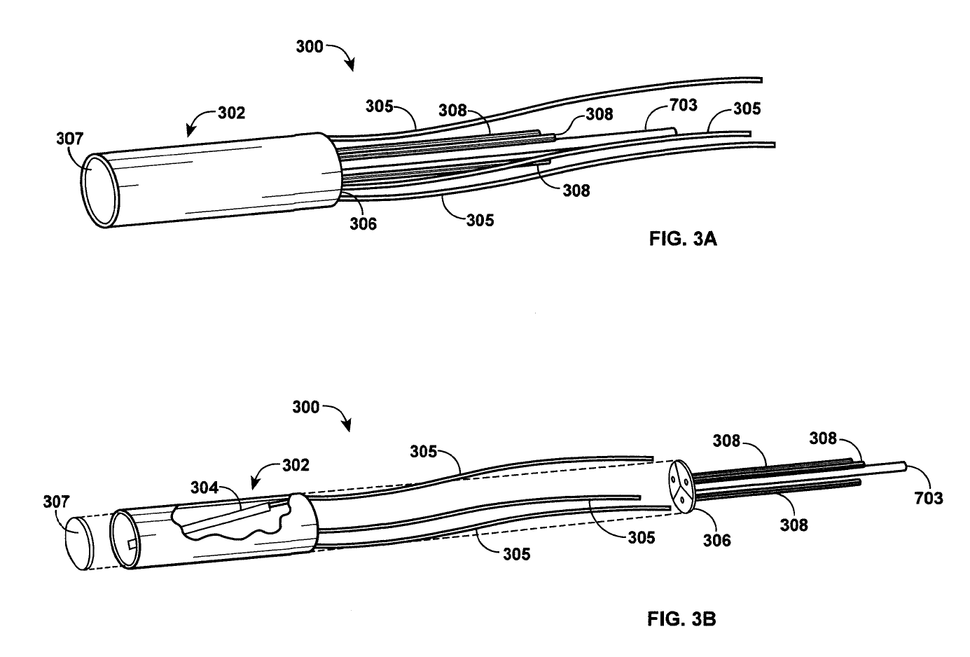

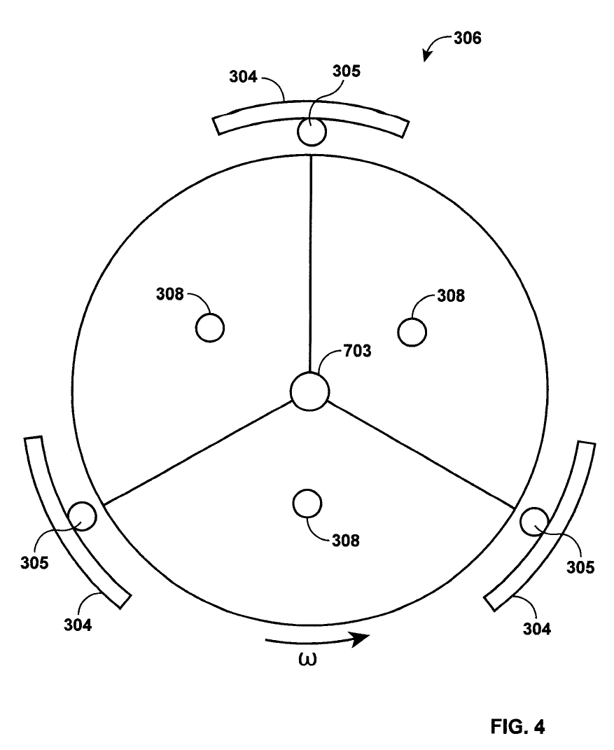

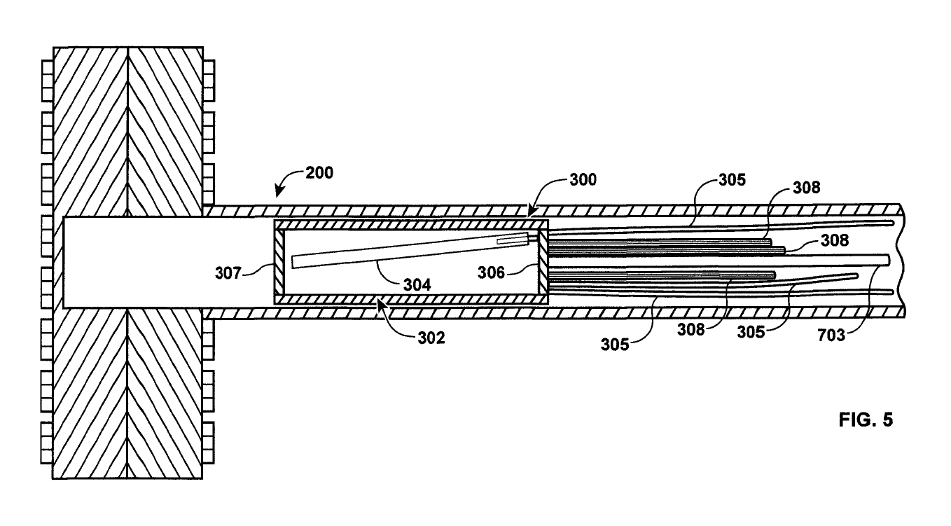

There are provided at least three input electrodes disposed at least partially within the chamber and configured to receive the first three phase alternating current into the chamber; the at least three input electrodes are configured to direct the first AC current to induce motion in the plasma. There also are provided at least three output electrodes extending from the chamber, and the at least three output electrodes are configured to conduct a second AC current from the chamber, the voltage or current of the AC current outputted from the chamber is based on the induced motion in the plasma. In a preferred embodiment, the input electrodes are helical electrodes 304 seen in FIG. 3B, which are in signal communication with the leads 305, while the output electrodes are split endcap 306 transmitting to its associated leads 308. Preferably, and as suggested by FIGS. 1A and 4, the input electrodes, particularly the helical electrodes 304, are equally spaced around the chamber circumference; i.e., three input electrodes are uniformly separated by 120 degrees.

FIG. 3A and FIG. 3B illustrate a transformer assembly 300 in accordance with the disclosed system and method. The transformer assembly comprises a housing 302 having three or more electrodes 304 (only one shown in FIG. 3B) disposed therein and/or extending there from. As an example, the electrodes 304 can be disposed in the chamber 200 of FIG. 2; that is, the housing or chamber 302 of FIGS. 3A-B in at least one embodiment may be analogous to the chamber 200. As shown, the electrodes 304 are helically wound within the chamber, and preferably have a 10:1 twist (e.g., the electrodes travel 10 times as far in the axial direction as they do in the poloidal (azimuthal direction)). Other twists can be used and ratios can be used. For example, twists can range from about 1:50 to about 1:1 axial to poloidal ratio. The electrodes 304 serve as the primary for the AC transformer system according to this disclosure. Voltage and current can be applied across the electrodes 304, for example, via leads 305. Accordingly, the applied electric field is perpendicular to the applied magnetic field from conductor 202 shown in FIG. 2.

The electrodes 304 when actuated thus induce rotation in the plasma via the ExB drift. Because the electrodes 304 are helical in configuration and arrangement relative to the axis of the chamber 300, this rotation is sheared in the axial direction. The result is that the field lines are bent and an axial current is induced.

The housing 302 can be formed from ceramic or electrical insulators such as plastic or composite materials. Moreover, end caps 306 and 307 preferably are disposed at opposite ends of the housing 302. First endcap 306 is the split electrode, i.e., with three insulated segments as seen in FIGS. 1A and 4. In the depicted embodiment, endcap 307 is a solid electrode. In an aspect, the split electrode end cap 306 forms the secondary of the transformer. The end caps 306 and 307 preferably are conductive and are capable of capturing the voltage and current that is generated parallel to the magnetic field. 703 is the rotation stalk.

Reference is made to FIG. 4, which illustrates the outside of the electrode shown in FIG. 1A and in FIGS. 3A-3B. The split electrode is labeled as 306, and the leads for the secondary are labeled as 308. The primary electrodes 304 and their leads 305 are also shown, as well as the rotation direction w. Shaft 703 is the rotation stalk for rotating the split electrode 306.

As shown in FIG. 5, the transformer assembly 300 of FIGS. 3A-3B may in a preferred embodiment be disposed in the vacuum chamber 200 of FIG. 2. In another aspect, the three or more helical electrodes 304, which are within and/or extending from the housing 302, are powered by a first electric current. Three or more conductors carry the second current from the end cap 306, and in the preferred embodiment these constitute the secondary of the transformer assembly. Three or more terminals 308 can be coupled to the end cap 306 to allow the secondary current to be transmitted to a remote location for use. Again, element 703 is the rotation stalk.

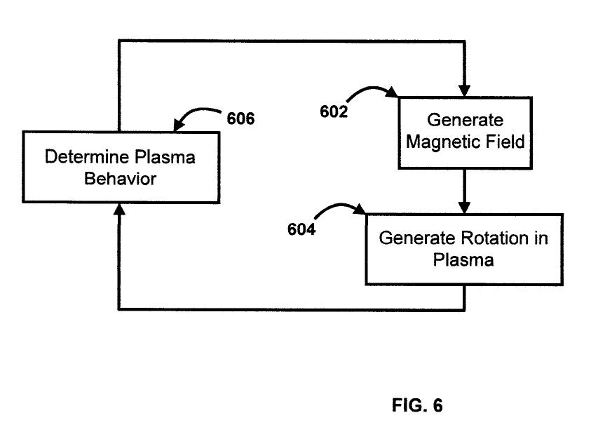

The flowchart of FIG. 6 illustrates that a method according to this disclosure can comprise generating a magnetic field through a plasma (step 602) and thus generating a rotation in the plasma (step 604), thereby generating an electric current. The magnetic field can be generated by a solenoid assembly. As an example, the solenoid assembly can be disposed around the plasma, such as a solenoid housing. In an aspect, the rotation can be sheared in an axial direction relative to the plasma, and the current is generated in the axial direction. A drift speed of the plasma is a factor (e.g., fraction or multiple) of the Alfven Speed, as previously explained. For example, the drift speed of the plasma can be between about 0.01 and about 400 times the Alfven speed. As a further example, the drift speed can be between about 0.01 and about two times the Alfven speed, between about 0.01 and about 10 times the Alfven speed, between about 0.01 and about 100 times the Alfven speed, between about 0.01 and about 200 times, or between about 0.01 and about 300 times the Alfven speed. Other ranges of factors can result from the systems and methods of the present disclosure. In another aspect, generating a rotation in the plasma comprises generating one or more of a partial laminar flow and a turbulent flow in the plasma. In a further aspect, plasma behavior can be determined (e.g., estimated, simulated) using an MHD simulation (step 606). Accordingly, the magnetic field and rotation generated can be configured based on the MHD simulation.

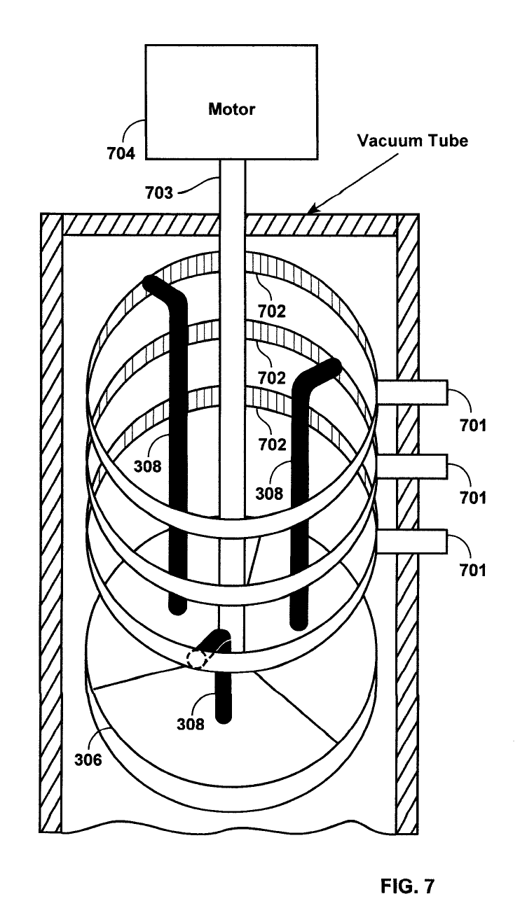

FIG. 7 depicts an end assembly of the chamber 200. Motor 704 rotates the split electrode 306 at a regulatable speed. The secondary leads 308 in this embodiment are rods which individually rub against the stationary conducting rings 702. As indicated in FIG. 7, each rod lead 308 is associated with a single segment of the split electrode, and each lead 308 also makes electrically conductive rubbing contact with a single corresponding ring 702. Current in a particular ring 702 is output via its respective terminal 701. The second three phase AC leaves the chamber through the conducting terminals 701. The rotating stalk 703 also exits the chamber before it connects to the motor. The RPM of the motor is controlled, and may be regulated to vary the rotational speed and direction of the split electrode, therefore to regulate the frequency of the AC output of the system.

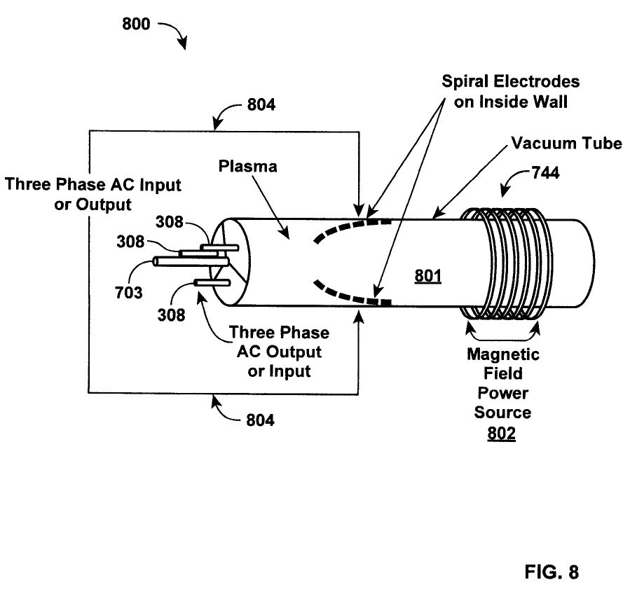

FIG. 8 is a circuit diagram illustrating an example system for transforming electrical current. In an aspect, the system 800 can comprise the apparatus 801 (e.g., AC-AC transformer assembly) as described herein. For example, the apparatus 801 can comprise a transformer configured to transform a first three phase alternating current to a second three phase alternating current. The system 800 can comprise a magnetic field power source 802. The magnetic field source can comprise a current source, voltage source, and/or the like configured to provide current and/or voltage to the solenoid 744 (e.g., thereby generating a magnetic field along the axis of the solenoid 744). The current and/or voltage are selectable to cause a target current and/or target voltage to be induced from the apparatus 801. The system 800 preferably includes input lines 804. Input lines 804 are electrically conductive paths. The input lines 804 can be configured to carry a first three phase alternating current to the apparatus 801. For example, the input lines 804 can be electrically coupled to the at least three input electrodes 304 (e.g., electrodes 304 in FIGS. 4 and 5) of the apparatus 801. The system 800 preferably also comprises output lines 308. The output lines 308 are electrically conductive paths. The output lines 308 can be configured to carry a second three phase alternating current from the apparatus 801. For example, the output lines 308 can be electrically connected to the at least three output electrodes terminals 701, as shown in FIG. 7. In an aspect, the output lines 308 can be electrically coupled to an electrical delivery network configured to conduct the three phase alternating current to at least one remote location (e.g. a remote component of a device, a remote device in a system, a remote power station).

Furthermore, the system 800 can also be run in reverse where the split electrode 306 defines the primary and the helical electrodes 304 define the secondary of the transformer assembly. Thus a step down transformer can also be used as a step up transformer by running it backwards. This is noted in FIG. 8 by labeling the leads as both input and output.

There thus has been disclosed a transformer system 800 configured to transform a first alternating three phase current to a second alternating three phase current. The transformer preferably includes a chamber 200 configured to contain plasma, at least three input electrodes 304 disposed at least partially within the chamber and configured to direct the first alternating three phase current to induce motion in the plasma, thereby generating the second alternating three current, at least three output electrodes 306 (i.e., a split electrode) extending from the chamber 200 and configured to conduct the second alternating three phase current from the chamber. There preferably is provided an electrical delivery network, which includes output leads 308 electrically connected to the at least three output electrodes 306 and configured to conduct the second alternating three phase current to at least one remote location. The at least three input electrodes 304 preferably comprise at least one helically shaped portion.

The chamber 200 comprises an end cap 307 and a split electrode 306 disposed at opposite ends of the chamber, and wherein the split electrode conveys a second three phase AC current from the chamber. The at least three input electrodes 304 preferably are a set of electrodes equally spaced around and at least partially within the chamber. The transformer system 800 further comprises a solenoid 744 disposed around at least a portion of an external wall of the chamber, such that an electric current passing through the solenoid induces a magnetic field within the chamber in an axial direction of the solenoid.

According to the system operation, the induced the motion in the plasma distorts the magnetic field, thereby inducing the second three phase alternating current within the chamber. Optionally, the system eliminates voltage pulses by the Paschen breakdown character of the plasma within the chamber.

Advantageously, the transformer system is adapted to be operable in reverse, in which the split electrode 306 functions as the input electrodes, and the helical electrodes 304 function as the output electrodes rather than as the input.

The system 800 can be integrated into and/or implemented in a variety of devices, systems, and/or applications, such as commercial buildings, homes, factories and the like.

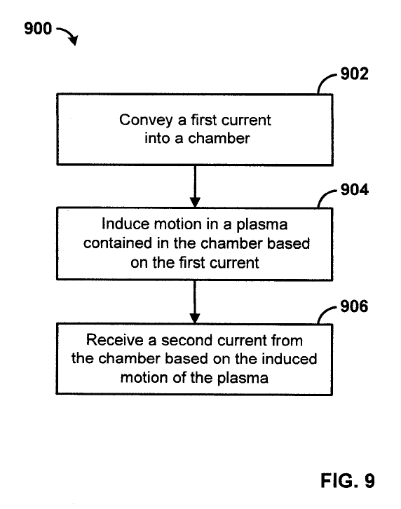

Attention is advanced to FIG. 9, providing a flow chart illustrating an example method 900 for transforming and/or converting a voltage and/or an electrical current. At step 902, a first current can be conveyed (e.g., provided, carried, transported, channeled) into a chamber. The first current preferably comprises a three phase alternating current. The first current can comprise a first voltage. For example, the first current can be conveyed to the chamber from a component of a power plant, power station, power line, and/or the like. The first current can be conveyed into the chamber via three or more electrodes (e.g., three, six, nine electrodes in number, in sets of three). The three or more electrodes can be disposed at least partially within the chamber. For example, the three or more electrodes can each comprise a first portion extending outside of the chamber and a second portion within the chamber.

The chamber may contain a gas, plasma, and/or the like. For example, the chamber can be filled with a gas, such as argon or hydrogen. The gas can be converted to plasma before, at the time of, or after the first current is conveyed to the chamber. The plasma and/or gas can be filled to a specified pressure (e.g., 1 mtorr) to achieve a desired behavior (e.g., motion) of the plasma and/or gas. The chamber can be configured (e.g., shaped) to cause, direct, constrain, control, and/or the like motion of the plasma within the chamber. For example, the chamber can be cylindrically shaped.

In one embodiment, the gas behaves likes a Paschen gas, and hence the applied voltage (to the primary) is limited by the Paschen breakdown voltage, as previously known in the art of gas electrophysics and discussed in: Friedrich Paschen (1889). “Ueber die zum Funkenübergang in Luft, Wasserstoff and Kohlensäure bei verschiedenen Drucken erforderliche Potentialdifferenz (On the potential difference required for spark initiation in air, hydrogen, and carbon dioxide at different pressures)”, Annalen der Physik. 273 (5): 69-75 (1889). Accordingly, the transformer is voltage limited and any voltage pulses in the primary will not be transmitted to the secondary. Rather, such pulses will be dissipated in the plasma.

According to the system and method, a magnetic field can be generated through the plasma. For example, a wire proximate the chamber can generate a magnetic field. The wire, which may define a solenoid, can be disposed (e.g., wrapped) around an exterior wall of the chamber. In an aspect, a protective layer (e.g., cover, shroud) can be disposed in between the wire and the chamber, as suggested by FIG. 2.

At step 904 of FIG. 9, motion can be induced in a plasma contained within the chamber based on the first current. For example, the first current can generate a second magnetic field within the chamber. The second magnetic field can be based on the path of the first current. For example, the three or more electrodes can be disposed, shaped, or the like, to generate an electric field between at least two of the three or more electrodes. In an aspect, the electric field can be a helically symmetric electric field. For example, the electric field can be rotated along the axis of the chamber. The electric field can cause, at least in part, the second current and/or the second voltage to be generated within the chamber.

Inducing the motion in the plasma can distort the magnetic field thereby inducing a second current within the chamber. Inducing motion in the plasma can comprise providing the first current through at least three helical electrodes within the chamber. The induced motion can comprise rotation sheared in an axial direction relative to the plasma. Induced motion can comprise a differential rotation in the plasma. The induced plasma motion may comprise a turbulent flow, a laminar flow, or a combination thereof. For example, the motion can be along a first direction at the center of the chamber. The motion can be along a second direction along interior walls of the chamber. The second direction can be opposite the first direction. The first direction and the second direction can be directions along (e.g., parallel to) the axis of the chamber.

At step 906, the second current can be received from the chamber based on the induced motion of the plasma. The second current preferably is a three phase alternating current. As an illustration, the first current can comprise a three phase alternating current and the second current can comprise a three phase alternating current.

The second current can be generated in an axial direction (e.g., along an axis or length of the chamber). For example, the second current can be generated along a line extending from a top (e.g., top cap) of the chamber to a bottom (e.g., bottom cap) of the chamber.

Furthermore, the first current can be conveyed with a first voltage. The second current can be conveyed with a second voltage. The second voltage can be a high voltage or low voltage in comparison to the first voltage. For example, the second voltage can be X (e.g., 1 2, 3, 4, 5, etc.) orders of magnitude greater or less than the first voltage.

There is disclosed, therefore, a method featuring the main steps of conveying a first alternating three phase current into a chamber, inducing motion in a plasma contained in the chamber based on the first alternating three phase current, and receiving a second alternating three phase from the chamber based on the motion induced in the plasma. The method includes the additional step of generating a magnetic field through the plasma, and inducing the motion in the plasma distorts the magnetic field, thereby inducing the second alternating three phase current within the chamber. The step of inducing motion in the plasma preferably comprises providing the first alternating three phase current through at least three helical electrodes within the chamber. Inducing motion in the plasma preferably also includes inducing a rotation sheared in an axial direction relative to the plasma; the second alternating three phase current is generated in the axial (secondary) direction. Inducing motion may comprise generating a turbulent flow, a laminar flow, or a combination thereof of turbulent and laminar flows in the plasma; furthermore, the step of inducing motion may include inducing a differential rotation in the plasma.

In the method, conveying a first alternating three phase current comprises conveying with a first voltage, as well as the step of conveying the second alternating three phase current with a second voltage. A version of the method features rotating a rotatable split electrode to convert the axially directed currents within the chamber to the second three phase alternating current alternating current. Thus the step of rotating a rotatable split electrode includes converting the axial currents in the chamber to three phase alternating current, and the controllably rotating the split electrode with a rotary motion alters the phase and frequency of the three phase AC power in the secondary.

The foregoing examples are offered so as to provide those of ordinary skill in the art with a further disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This is true for any possible non-express basis for interpretation, including: matters of logic with respect to arrangement of steps or operational flow; plain meaning derived from grammatical organization or punctuation; the number or type of embodiments described in the specification.

Various publications are referenced hereinabove. The disclosures of these publications in their entireties are hereby incorporated by reference into this application in order to more characterize the state of the art to which the methods and systems pertain.

It will be apparent to those skilled in the art that various modifications and variations can be made without departing from the scope or spirit of the disclosed invention. Other embodiments will be apparent to those skilled in the art from consideration of the specification and practice disclosed herein. It is intended that the specification and examples be considered as exemplary only, with the scope of the invention being defined by the claims appended hereto.

What is claimed is:

1. An apparatus comprising:
a chamber configured to contain plasma;
at least three input electrodes disposed at least partially within the chamber and configured to receive a first three phase alternating current into the chamber, wherein the at least three input electrodes are configured to direct the three phase alternating current to induce motion in the plasma; and
at least three output electrodes extending from the chamber, wherein the at least three output electrodes are configured to conduct a second three phase alternating current from the chamber based on the induced motion in the plasma.

2. The apparatus of claim 1, wherein the at least three input electrodes are equally spaced around the chamber.

3. The apparatus of claim 1, wherein the chamber comprises an end cap and a split electrode disposed at opposite ends of the chamber, and wherein all output electrode leads of the at least three output electrodes are disposed from the split electrode.

4. The apparatus of claim 1, further comprising a solenoid disposed around at least a portion of an external wall of the chamber, wherein an electric current passing through the solenoid induces a magnetic field within the chamber in an axial direction of the solenoid.

5. The apparatus of claim 4, wherein the magnetic field is caused by the induced motion to align at least in part with magnetic fields caused by at least a portion of the at least three input electrodes, thereby inducing the second direct current within the chamber.

6. The apparatus of claim 4, further comprising a protective cover disposed between the solenoid and the chamber.

7. The apparatus of claim 1, wherein the at least two input electrodes comprise at least three helical electrodes.

8. A method comprising:
conveying a first alternating three phase current into a chamber;
inducing motion in a plasma contained in the chamber based on the first alternating three phase current; and
receiving a second alternating three phase from the chamber based on the induced motion of the plasma.

9. The method of claim 8, further comprising generating a magnetic field through the plasma, and wherein inducing the motion in the plasma distorts the magnetic field thereby inducing the second alternating three phase current within the chamber.

10. The method of claim 8, wherein inducing motion in the plasma comprises providing the first alternating three phase current through at least three helical electrodes within the chamber.

11. The method of claim 8, wherein inducing motion comprises inducing a rotation sheared in an axial direction relative to the plasma, and wherein the alternating three phase current is generated in the axial (secondary) direction.

12. The method of claim 8, wherein conveying a first alternating three phase current comprises conveying with a first voltage, and further comprising conveying the second alternating three phase current with a second voltage.

13. The method of claim 11 further comprising rotating a rotatable split electrode to convert the axially directed currents in the chamber to the second three phase alternating current alternating current.

14. The method of claim 8 further comprising rotating a rotatable split electrode to convert the axial currents in the chamber to three phase alternating current, and wherein the rotary motion of the split electrode can alter the phase and frequency of the three phase AC power in the secondary.

15. The method of claim 8, wherein the inducing motion comprises generating a turbulent flow, a laminar flow, or a combination thereof of turbulent and laminar flows in the plasma.

16. The method of claim 8, wherein inducing motion comprises inducing a differential rotation in the plasma.

17. A system comprising a transformer configured to transform a first alternating three phase current to a second alternating three phase current, the transformer comprising,
a chamber configured to contain plasma;
at least three input electrodes disposed at least partially within the chamber and configured to direct the first alternating three phase current to induce motion in the plasma, thereby generating the second alternating three current;
at least three output electrodes extending from the chamber and configured to conduct the second alternating three phase current from the chamber; and
an electrical delivery network electrically coupled to the at least three output electrodes and configured to conduct the second alternating three phase current to at least one remote location.

18. The system of claim 17, wherein the at least three input electrodes comprise at least one helically shaped portion.

19. The system of claim 17, wherein the chamber comprises an end cap and a split electrode disposed at opposite ends of the chamber, and wherein the split electrode conveys a second three phase AC current from the chamber.

20. The system of claim 17, wherein the at least three input electrodes comprise a set of electrodes are equally spaced around the chamber.

21. The system of claim 17, wherein the transformer further comprises a solenoid disposed around at least a portion of an external wall of the chamber, and wherein an electric current passing through the solenoid induces a magnetic field within the chamber in an axial direction of the solenoid.

22. The system of claim 21, wherein the induced the motion in the plasma distorts the magnetic field thereby inducing the second three phase alternating current within the chamber.

23. The system of claim 21, wherein the system eliminates voltage pulses by the Paschen breakdown character of the plasma within the chamber.

24. The system of claim 17, wherein the system is adapted to be operable in reverse whereby the split electrode functions as the input electrode and the helical electrodes function as the output electrodes.
